(19) United States
(12) Patent Application Publication
(10) Pub. No.: US 2010/0238499 A1
(43) Pub. Date: Sep. 23, 2010

(54) INFORMATION PROCESSING APPARATUS CAPABLE OF EXECUTING CONVENIENT PRINT SETTING, METHOD OF CONTROLLING INFORMATION PROCESSING APPARATUS, AND RECORDING MEDIUM HAVING CONTROL PROGRAM FOR INFORMATION PROCESSING APPARATUS RECORDED THEREON

(75) Inventors: Katsuaki WAKUI, Toyokawa-shi (JP); Tetsuya Tokumoto, Toyokawa-shi (JP); Tomoyuki Atsumi, Toyohashi-shi (JP); Yuji Kawamura, Hachioji-shi (JP); Takuya Okada, Toyokawa-shi (JP)

Correspondence Address: MORRISON & FOERSTER LLP, 1650 TYSONS BOULEVARD, SUITE 400, MCLEAN, VA, 22102, US

(73) Assignee: Konica Minolta Business Technologies, Inc., Tokyo (JP)

(21) Appl. No.: 12/726,645

(22) Filed: Mar. 18, 2010

(30) Foreign Application Priority Data
Mar. 19, 2009 (JP) 2009-067841

(51) Int. Cl. G06F 3/12

(52) U.S. Cl. 358/1.15

(57) ABSTRACT

A driver core determines whether or not an operation to change print settings in a print setting screen is performed by the user. If a changing operation is not performed, the process is skipped. On the other hand, if a changing operation is performed on an item of print settings through input using a mouse, a keyboard, or the like, the driver core obtains print setting information before the changing operation. Then, history data is created. Then, if it is determined that no identical history data exists, the history data is saved.

This application is based on Japanese Patent Application No. 2009-067841 filed with the Japan Patent Office on Mar. 19, 2009, the entire content of which is hereby incorporated by reference.

### BACKGROUND OF THE INVENTION

1. Field of the Invention

The present invention relates to a printing technique for printing output information from software applications (ex. word processors) operating on computers.

2. Description of the Related Art

In conventional printing systems, when printing print data (data files created by applications) saved in secondary storage devices of computers, users execute printing through the following procedure.

A description will be made, for example, to a case where Windows® is used as Operating System (OS) of computers. On this operating system, data to be printed is saved in the form of file data.

A user finds the file data to be printed and then starts the application that created the file data (for example, a word processor that is a document editing application, spreadsheet software, or the like) to open the file data to be printed.

Then, a print instruction provided as a service of the application is executed to do printing.

More specifically, a printing process in a computer is performed by starting a document editing application on a computer, performing such processing as creating a new document or opening a saved document file for editing, and then activating a printing processing function of the document editing application for performing the printing process.

Upon execution of the printing process, the document editing application invokes a printer driver through an intermediate module (GDI (Graphical Device Interface) under the OS on the computer, so that the invoked printer driver creates PDL (page description language) that can be interpreted by a controller of an image forming apparatus for doing printing.

When the user clicks on a print menu during processing on the document editing application, a user interface for print settings concerning printing appears.

Specifically, a variety of items concerning print settings, such as paper size, resolution, paper orientation, and number of copies, can be set. The document editing application can hold the setting items.

Japanese Laid-Open Patent Publication Nos. 2001-256007 and 2002-149365 disclose that print settings for each print job are left as a print history so that data created by a document editing application and once printed can be reset and printed again easily.

However, in a case where print settings are registered in a document editing application, if the document editing application is saved with the print settings changed, the original print settings may be lost.

In other words, while the print settings can be left as a history after execution of a printing process, the print settings before printing are not saved as a history. Therefore, if print settings are changed several times before a printing process, the previous state of print settings cannot be recovered. In addition, when a history of changes of print settings is to be left, such cumbersome operations as taking notes of the print settings are necessary.

### SUMMARY OF THE INVENTION

The present invention is made to solve the aforementioned problem. An object of the present invention is to provide an information processing apparatus capable of executing print setting convenient for users, a method of controlling an information processing apparatus, and a control program for an information processing apparatus.

According to an exemplary embodiment, an information processing apparatus transfers image data created by a software application operating on a computer to an image forming apparatus for printing. The information processing apparatus includes a display for displaying information and a controller for controlling the information processing apparatus. The controller displays a print setting screen on the display for setting print setting information showing a manner of printing of the image data in the image forming apparatus that is transferred in association with the image data when printing of the image data is to be executed. The controller then obtains print setting information before being changed in response to an operation to the print setting screen that receives a change of the print setting information, and saves the obtained print setting information before being changed into a memory as history information that is to be used for displaying on said display said print setting screen in relation to the saved print setting information.

Preferably, the print setting information set when printing of the image data is executed is stored in the memory in relation to the image data. The controller displays the print setting screen again on the display based on the saved print setting information stored in the memory in relation to the image data in response to an instruction. When the print setting screen is displayed again on the display, the saved print setting information stored in the memory is saved in the memory as the history information.

Preferably, the controller detects input of a saving instruction in the print setting screen to obtain the print setting information before being changed.

Preferably, the controller obtains the print setting information before being changed when the previous print setting information is changed to another print setting information.

Preferably, the controller obtains information of a creator of the image data and of a user of the computer, compares the information of the user of the computer with the information of the creator of the image data, and saves the print setting information before being changed as history information in the memory when the creator is different from the user.

Preferably, the controller allows the display to display a list of plural pieces of print setting information saved in the memory as the history information, in response to an instruction, accepts input of selection of one piece of print setting information from the list of plural pieces of print setting information, and displays a print setting screen in accordance with the selected print setting information on the display.

In particular, the controller allows the display to display the plural pieces of print setting information in chronological order.

In particular, the controller obtains information of a creator of the image data and of a user of the computer, compares the information of the user of the computer with the information of the creator of the image data, and allows the display to display the plural pieces of print setting information in chronological order when the creator is different from the user.

In particular, the controller obtains information of a creator of the image data and of a user of the computer, compares the information of the user of the computer with the information of the creator of the image data, and allows the display to display the plural pieces of print setting information in reverse chronological order when the creator and the user are identical.

In particular, the image data is managed with a file name in association with an identifier showing a software application that has created the image data among a plurality of identifiers respectively corresponding to a plurality of software applications. Plural pieces of other print setting information are saved in the memory in relation to respective plural pieces of image data. The controller saves the file name and the identifier corresponding to each image data in association with each other, together with the print setting information or the other print setting information, as the history information in the memory. The controller allows the display to display a list including print setting information corresponding to the identical file name among the print setting information and the plural pieces of other print setting information that are saved in the memory.

According to an exemplary embodiment, a method of controlling an information processing apparatus transferring image data created by a software application operating on a computer to an image forming apparatus for printing includes the steps of: displaying a print setting screen on a display for setting print setting information showing a manner of printing of the image data in the image forming apparatus that is transferred in association with the image data when printing of the image data is to be executed; obtaining print setting information before being changed in response to an operation to said print setting screen that receives a change of said print setting information; and saving the obtained print setting information before being changed into a memory as history information that is to be used for displaying on said display said print setting screen in relation to the saved print setting information.

Preferably, the method further includes the steps of: storing print setting information set when printing of the image data is executed, into the memory in relation to the image data; displaying the print setting screen again on the display based on the saved print setting information stored in the memory in relation to the image data in response to an instruction; and saving the saved print setting information in the memory as the history information when the print setting screen is displayed again on the display.

Preferably, the obtaining step includes the step of obtaining the print setting information before being changed when the print setting information is changed to another print setting information.

Preferably, the obtaining step includes the step of obtaining information of a creator of the image data and of a user of the computer. The information of the creator of the image data is compared with the information of the user of the computer. The print setting information before being changed is saved in the memory as history information when the creator is different from the user.

Preferably, the method further includes the steps of: allowing the display to display a list of plural pieces of print setting information saved in the memory as the history information, in response to an instruction; accepting input of selection of one piece of print setting information from the list of plural pieces of print setting information; and displaying a print setting screen in accordance with the selected print setting information, on the display.

According to an exemplary embodiment, a recording medium has a control program recorded thereon for an information processing apparatus that transfers image data created by a software application operating on a computer to an image forming apparatus for printing. The control program allows the computer to execute the steps of: displaying a print setting screen on a display for setting print setting information showing a manner of printing of the image data in the image forming apparatus that is transferred in association with the image data when printing of the image data is to be executed; obtaining print setting information before being changed in response to an operation to said print setting screen that receives a change of said print setting information; and saving the obtained print setting information before being changed into a memory as history information that is to be used for displaying on said display said print setting screen in relation to the saved print setting information.

Preferably, the control program allows the computer to further execute the steps of: storing print setting information set when printing of the image data is executed, into the memory in relation to the image data; displaying the print setting screen again on the display based on the saved print setting information stored in the memory in relation to the image data in response to an instruction; and saving the saved print setting information in the memory as the history information when the print setting screen is displayed again on the display.

Preferably, the obtaining step includes the step of obtaining the print setting information before being changed when previous print setting information is changed to another print setting information.

Preferably, the obtaining step includes the step of obtaining information of a creator of the image data and of a user of the computer. The information of the creator of the image data is compared with the information of the user of the computer. The print setting information before being changed is saved in the memory as history information when the creator is different from the user.

Preferably, the control program allows the computer to further execute the steps of: allowing the display to display a list of plural pieces of print setting information saved in the memory as the history information, in response to an instruction; accepting input of selection of one piece of print setting information from the list of plural pieces of print setting information; and displaying a print setting screen in accordance with the selected print setting information, on the display.

The above-noted information processing apparatus obtains print setting information before being changed in a print setting screen that allows setting of print setting information to be changed. The obtained previous print setting information before being changed is saved in a memory as history information that can display a print setting screen according to the previous print setting information later on a display. Therefore, the previous print setting information before being changed can be viewed as history information so that print setting convenient for users can be executed.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing a configuration of a printing system in accordance with a first embodiment of the present invention.

FIG. 2 is a schematic block diagram showing a PC in accordance with the first embodiment of the present invention.

FIG. 3 is a functional block diagram showing a processing structure concerning a printing function in a main body portion of the PC shown in FIG. 2.

FIG. 4 shows a print setting screen displayed on a display by a setting display portion of a driver GM.

FIG. 5 is a functional block diagram of a print setting history data management portion in accordance with the first embodiment of the present invention.

FIG. 6 shows print setting history data stored in a history database.

FIG. 7 is a flowchart showing a process procedure of the driver GUI in accordance with the first embodiment of the present invention.

FIG. 8 is a flowchart showing a process of the printer driver in case where a print execution instruction is given in accordance with the first embodiment of the present invention.

FIG. 9 is a flowchart showing a history list table displayed based on the history data stored in the history database.

FIG. 10 illustrates that the history list table is displayed in the print setting screen.

FIG. 11 is a flowchart showing a process in a case where a history item is selected in accordance with the first embodiment of the present invention.

FIG. 12 illustrates a print setting screen in accordance with a second embodiment of the present invention.

FIG. 13 is a flowchart showing a process procedure of the driver GUI in accordance with the second embodiment of the present invention.

FIG. 14 is a flowchart showing a process of the printer driver in a case where a print execution instruction is given in accordance with a third embodiment of the present invention.

FIG. 15 is a flowchart showing a process procedure of the driver GUI in accordance with the third embodiment of the present invention.

FIG. 16 illustrates that a history list table is displayed on a print setting screen.

FIG. 17 is a flowchart showing display of the history list table in accordance with a fourth embodiment of the present invention.

FIG. 18 is a flowchart showing display of the history list table in accordance with a fifth embodiment of the present invention.

FIG. 19 illustrates that a history list table is displayed in a print setting screen.

### DESCRIPTION OF THE PREFERRED EMBODIMENTS

In the following, embodiments of the present invention will be described with reference to the drawings. In the following description, the same parts and components are denoted with the same reference numerals. Their designations and functions are the same.

### First Embodiment

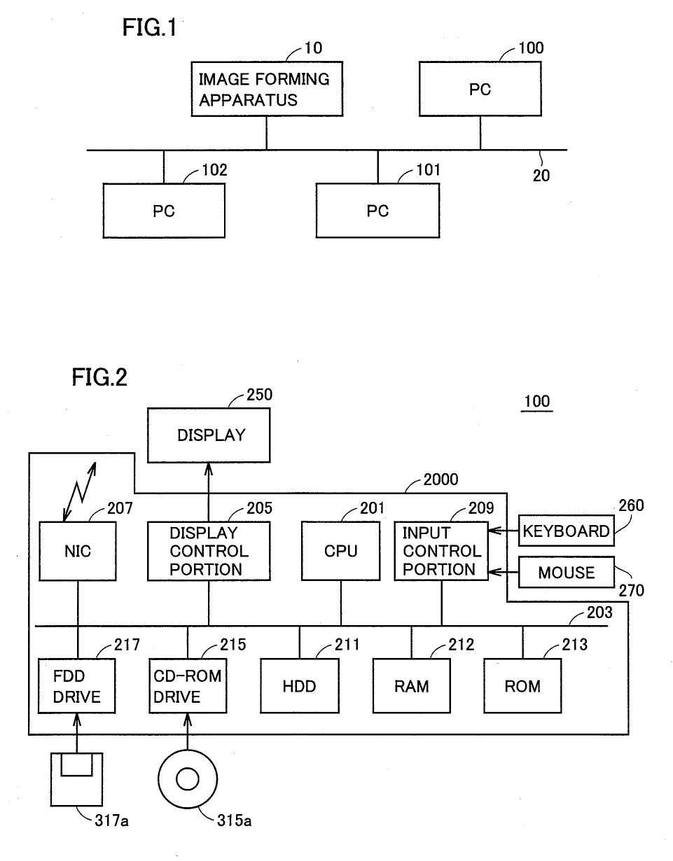

A configuration of a printing system in accordance with a first embodiment of the present invention will be described using FIG. 1.

Referring to FIG. 1, an information processing system is configured with an image forming apparatus 10 and personal computers (hereinafter also simply referred to as PC) 100-102 that are information processing apparatuses connected via a network such as LAN (Local Area Network) 20. Each PC 100-102 and image forming apparatus 10 are connected so that they can communicate data with each other via LAN 20. In the present invention, image data created on an application running on each PC 100-102 is output as a print job to image forming apparatus 10, so that the image data created on each PC 100-102 is received and subjected to a printing process in image forming apparatus 10.

It is noted that a description is made here to a configuration in which three PCs are connected as information processing apparatuses with LAN 20. However, the number of PCs is not limited to three as long as at least one is provided. Furthermore, the present invention is not limited to LAN, and WAN (Wide Area Network) or the like may be employed.

A schematic block diagram of PC in accordance with the first embodiment of the present invention will be described using FIG. 2.

Referring to FIG. 2, PC 100 in accordance with an embodiment of the present invention is configured with a main body portion 2000, a display 250 as display means, and a keyboard 260 as key input means and a mouse 270 as a pointing device which serve as input means. Here, these main body portion 2000, display 250, and keyboard 260 and mouse 270 as input means are separately provided. However, they may be provided integrally with main body portion 2000.

Display 250 may be a liquid crystal display, a CRT (Cathode Ray Tube) display device, a plasma display device, or any other device as long as it is capable of displaying.

Main body portion 2000 includes a CPU (Central Processing Unit) 201 for executing a variety of programs including an Operating System (OS), a RAM 212 temporarily storing data necessary to execute a program portion of CPU 201, a hard disk portion (HDD: Hard Disk Drive) 211 storing in a nonvolatile manner data and a program executed in CPU 201, and a ROM 213 storing beforehand a program to be executed on CPU 201. OS is stored beforehand in ROM 213 or HDD 211 and executed to run a variety of applications.

In addition, a printer driver that is a software program for transmitting print jobs to image forming apparatus 10 is stored in HDD 211. The printer driver is read by CPU 201 to implement a function as described later.

Such a program is read by an FD drive 217 or a CD-ROM (Compact Disc-Read Only Memory) drive 215 from a flexible disk 317a or a CD-ROM 315a, respectively. Then, the read program is stored in HDD 211 for use. It is noted that although the program is read from flexible disk 317a, CD-ROM 315a, or the like in this example, the present invention is not limited thereto, and it may be downloaded from a not-shown server in which a printer driver is stored, through LAN 20. Furthermore, although key board 260 and mouse 270 are exemplified as input means in this example, a touch panel may be provided so that input may be done through the touch panel.

CPU 201 accepts an instruction from the user through an operation of keyboard 260 or mouse 270 through an input control portion 209 connected with keyboard 260 or mouse 270 and also outputs to a display control portion 205 a screen output generated through execution of a program.

Display control portion 205 outputs the screen output to display 250.

In addition, CPU 201 transmits a print job to image forming apparatus 10 connected with LAN 20 (or WAN or the like) through a network interface card (NIC) 207 formed of a LAN card or the like.

The aforementioned portions mutually receive and send data through an internal bus 203.

It is noted that the configuration of each PC 100-102 is similar and therefore a detailed description thereof will not be repeated.

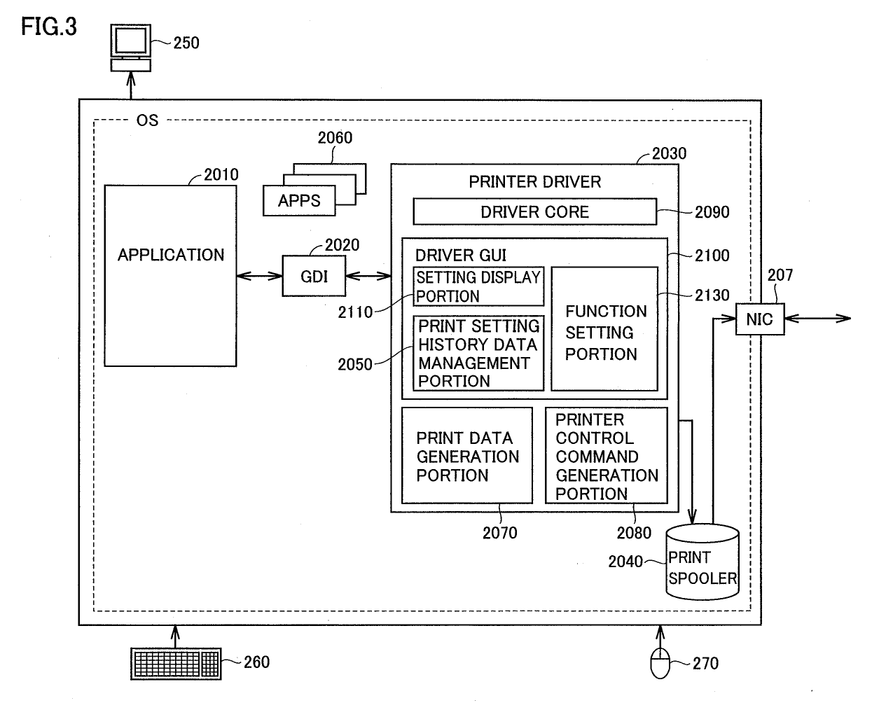

A functional block diagram showing a processing structure concerning a printing function in main body portion 2000 of PC 100 shown in FIG. 2 will be described using FIG. 3.

Referring to FIG. 3, “OS” shown on the rectangular broken line does not mean that each component in the rectangle is a component of an Operating System (hereinafter referred to as OS (for example, Windows®) but means that the components in the rectangle operate on the OS.

As described above, keyboard 260 as input means or mouse 270 as a pointing device and display 250 as display means are connected with main body portion 2000 of PC 100, thereby implementing a computer system.

It is assumed that main body portion 2000 operates under OS such as Windows®.

Focusing attention only to functional portions of main body portion 2000 that are related to the present invention, the functions on OS are largely classified into activated software application 2010, a Graphic Device Interface (referred to as GDI hereinafter) 2020 that is a part of OS, a printer driver 2030, and a print spooler 2040 temporarily storing data generated by printer driver 2030.

Their designations and functional frame works may vary depending on OS. For example, the designation of a module that is called a GDI printer driver is unique to Windows®, and the equivalent function in any other OS is implemented, for example, by a module called a graphic kernel or a print filter. Print spooler 2040 may also be implemented by incorporating processes in a module called a print queue.

In general, main body portion 2000 comprised of these components is under control of software called basic software (BIOS) under hardware such as CPU 201, HDD 211, RAM 212, and ROM 213 shown in FIG. 2. Software applications operate under that basic software.

Printer driver 2030 or the like is also designed as one of such software applications.

Software application 2010 is software for executing functions, for example, such as a word processor and a spreadsheet and refers to application software operating on the Operating System.

Furthermore, a plurality of software applications 2010 may be activated at any timing and are shown as apps 2060.

A description will now made to a case where any given document editing application is used as software application 2010.

When an operation of editing images such as texts or graphics is mainly performed by software application 2010 and the images are to be printed, a print menu displayed on display 250 is selected by mouse 270 or the like to allow printing to be done.

Then, software application 2010 calls GDI 2020 that is a partial function of the Operating System. GDI 2020 is a basic function group that governs a display device or a printing device for image display, print output, or the like. Various software applications from various companies use this basic function group to run software applications without regard to a device-dependent part (hardware).

Then, GDI 2020 takes in information such as drawing ability and print resolution held by a printing device (here, image forming apparatus 10), from printer driver 2030 that manages information dependent on the kind of printing device, processes API (Application Program Interface) function called from software application 2010, and calls a function provided for GDI 2020 by printer driver 2030 depending on the processed content.

The aforementioned function is a predetermined interface (Device Driver Interface (DDI)), and the creator of a printer driver creates the printer driver on the basis of data conversion for outputting data to the actual printing device from that interface.

Printer driver 2030 is configured with a driver core 2090 having control over the entire printer driver, a driver GUI 2100, a print data generation portion 2070, and a printer control command generation portion 2080.

Driver GUI 2100 is configured with modules, namely, a setting display portion 2110, a function setting portion 2130, and a print setting history data management portion 2050.

Setting display portion 2110 outputs a print setting screen for displaying print environment settings for the user to display 250 as display means. Function setting portion 2130 executes print environment setting (also simply referred to as print setting) in accordance with an input instruction from the user from keyboard 260 as input means or mouse 270 as a pointing device when the print setting screen is displayed. Print setting history data management portion 2050 manages history data in the case where an operation to change print environment settings is performed in accordance with an input instruction from keyboard 260 as input means or mouse 270 as a pointing device, as described later, when the print setting screen is displayed.

Printer driver 2030 executes a process of generating print data (drawing data) in print data generation portion 2070 and also performs a process of generating a printer control command in printer control command generation portion 2080, based on DDI information received from GDI 2020 and the print environment settings set by driver GUI (Graphical User Interface) 2100.

Then, the print data (drawing data) and the printer control command generated in accordance with the print execution instruction are output as a print job to print spooler 2040.

Then, the print job formed of these print data and printer control command is output from print spooler 2040 to image forming apparatus 10 through NIC 207.

Then, in image forming apparatus 10, a prescribed process is executed in accordance with the printer control command included in the print job, so that, for example, print data is printed on a recording sheet.

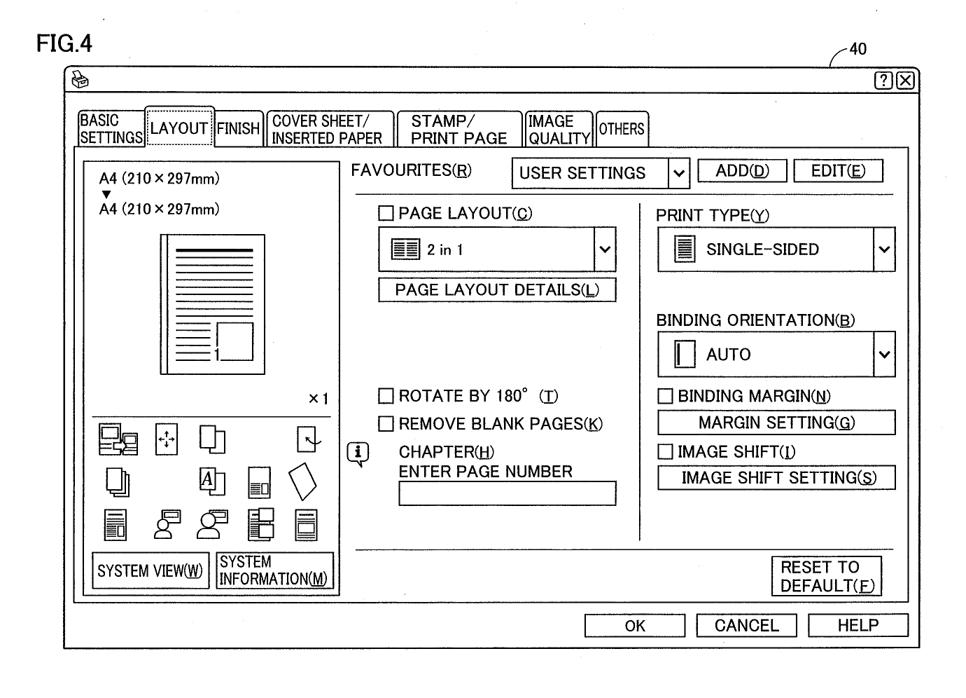

A print setting screen 40 that is displayed by setting display portion 2110 of driver GUI 2100 on display 250 will be described using FIG. 4.

Referring to FIG. 4, a variety of plurality of setting items concerning print environment settings can be set in print setting screen 40. Specifically, settings concerning a variety of print environments can be made by specifying a plurality of tabs classified by setting items provided on the top, using mouse 270 as a pointing device or keyboard 260.

In this example, a variety of setting items are displayed in a case where a tab “layout” regarding arrangement of image data is specified.

The user specifies a variety of tabs using mouse 270 or the like to set, for example, selection of printing paper, image quality, number of copies, and the like.

Furthermore, “others” tab is specified to display a list of history data of print settings, as described later.

Print setting history data management portion 2050 in accordance with the first embodiment of the present invention will now be described.

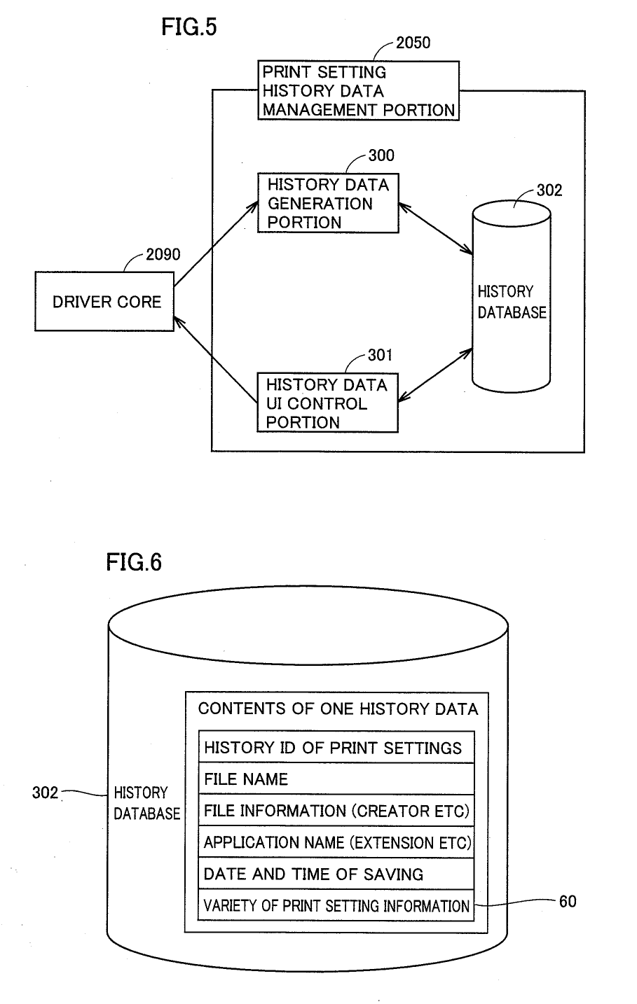

A functional block diagram of print setting history data management portion 2050 in accordance with the first embodiment will now be described using FIG. 5.

As shown in FIG. 5, print setting history data management portion 2050 is controlled under an instruction from driver core 2090.

Print setting history data management portion 2050 is mainly configured with modules, specifically, a history data generation portion 300, a history data UI control portion 301, and a history database 302.

History data of print settings (print setting history data) is stored in history database 302.

The print setting history data stored in the history database will now be described using FIG. 6.

Referring to FIG. 6, stored as the print setting history data are a history ID of print settings, a file name, file information (creator and the like), an application name (extension and the like), the date and time of saving, a variety of print setting information, and the like, which are collectively stored as a piece of history data.

History data generation portion 300 generates print setting history data in accordance with an instruction from driver core 2090, as necessary, and registers and saves the same in history database 302.

History data UI control portion 301, which is a module for mainly controlling the user interface in print setting history data management portion 2050, displays a list of print setting history data in a dialogue box, and accepts a selection input of print setting history data in the aforementioned print setting screen.

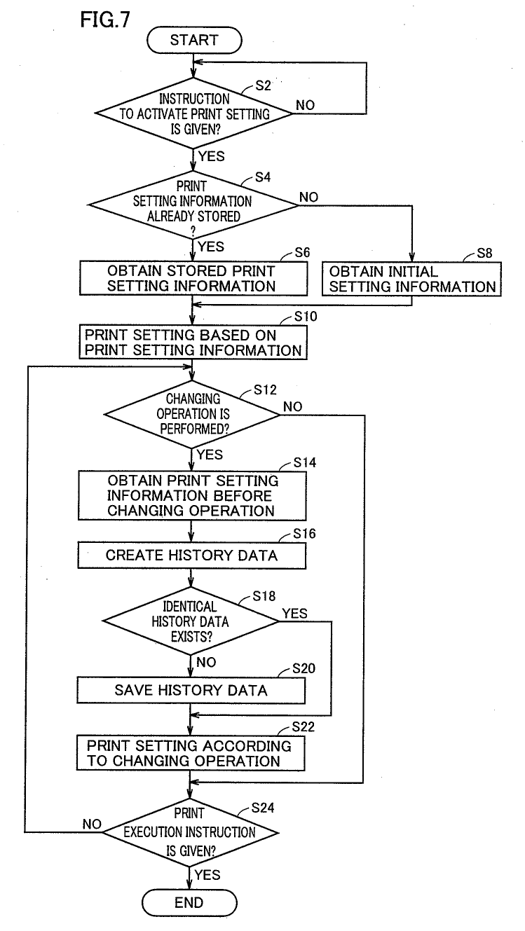

A process procedure of the driver GUI in accordance with the first embodiment will now be described using FIG. 7.

Referring to FIG. 7, first, driver core 2090 determines whether or not an instruction to activate print setting is given or not (step S2).

Specifically, it is determined whether or not input of an instruction to activate a print setting screen for executing print environment setting is given by activating a print processing function of a document editing application after the document editing application is started to perform processes such as creation of a new document and opening and editing of the saved document file. It is noted that an instruction to activate print setting may be started through the user's operation using a start button or may be started concurrently with starting of the document editing application. The starting method is not limited.

Then, if the instruction to activate print setting is executed in step S2, then driver core 2090 determines whether the print setting information has already been stored or not (step S4). The print setting information stored in HDD 211 or the like is the one set when the document editing application is started and a printing process is executed, as described later. In a scheme in accordance with the first embodiment, print setting information is stored for each application in HDD 211 or the like. Furthermore, in this example, the print setting information is updated for each application and then stored in HDD 211 or the like. However, only the initial setting information may be saved and the print setting information may not be updated.

If it is determined that the print setting information is stored in step S4, driver core 2090 obtains the print setting information stored in HDD 211 or the like (step S6).

On the other hand, if it is determined that the print setting information is not stored in step S4, driver core 2090 obtains the initial setting information (step S8). Specifically, when a printing process of print data is not executed, no print setting information is stored, and therefore the initial setting information that is preset print setting information is obtained from HDD 211 or the like.

Then, print setting is executed based on the obtained print setting information (step S10).

Specifically, driver core 2090 outputs the print setting information to function setting portion 2130. Function setting portion 2130 executes environment setting concerning printing that is previously set based on the print setting information output from driver core 2090. Alternatively, the initial environment setting concerning printing is executed. Then, setting display portion 2110 displays the aforementioned print setting screen on display 250.

Then, driver core 2090 determines whether or not an operation to change print settings is performed by the user on the print setting screen (step S12).

For example, the user can change an item of print settings on print setting screen 40 through input using mouse 270 as a pointing device or the like in print setting screen 40 illustrated in FIG. 4.

If a changing operation is not performed in step S12, the process skips to step S24 (NO in step S12).

On the other hand, if a changing operation is performed on an item of print settings through input using the mouse, the keyboard, or the like (YES in step S12), driver core 2090 obtains the print setting information before the changing operation (step S14).

Then, history data is created (step S16).

Specifically, driver core 2090 outputs the obtained print setting information before the changing operation to history data generation portion 300. History data generation portion 300 creates history data based on the obtained print setting information before the changing operation.

Then, it is determined whether identical history data exists or not (step S18).

Specifically, history data generation portion 300 accesses history database 302 to determine whether history data including the content of print setting information identical to the created history data exists or not.

If it is determined that no identical history data exists in step S18, the history data is saved (step S20).

Specifically, history data generation portion 300 saves the created history data in history database 302. Specifically, the history data as shown in FIG. 6 is saved in history database 302.

Then, print setting is executed in accordance with the changing operation (step S22). Specifically, function setting portion 2130 executes environment setting concerning printing based on the print setting information according to the changing operation output from driver core 2090.

Then, setting display portion 2110 displays the updated print setting screen as described above on display 250.

On the other hand, if it is determined that identical history data exists in history database 302 in step S18, the process skips to step S22. More specifically, environment setting concerning printing is executed by function setting portion 2130 based on the print setting information according to the changing operation, without the created history data being saved in history database 302.

Then, driver core 2090 determines whether a print execution instruction is given or not (step S24).

For example, whether a print execution instruction is given or not can be determined by whether or not the user specifies an “OK” button using mouse 270 or the like on print setting screen 40.

Then, if it is determined that a print execution instruction is given in step S24, the process in driver GUI 2100 is ended (END). Specifically, display of print setting screen 40 is terminated.

Then, if a print execution instruction is given, driver core 2090 outputs, to print data generation portion 2070 and printer control command generation portion 2080, the set print setting information and image data, which are then output to print spooler 2040 as a print job, as described above. Then, the print job formed of these print data and printer control command is output from print spooler 2040 to image formation apparatus 10 through NIC 207. A printing process is executed in image forming apparatus 10.

On the other hand, if it is determined that a print execution instruction is not given in step S24 (NO in step S24), the process returns to step S12 again, and input of an instruction for a changing operation is accepted from the user.

Then, the aforementioned processing is repeated.

Accordingly, every time the user performs an operation to change environment settings concerning printing in the print setting screen, history data that is print setting information before the changing operation can be created and then stored in history database 302.

As a result, even when the user performs an operation to change the environment settings concerning printing several times using mouse 270 or the like in the print setting screen, the user can obtain the past print setting information before the changing operation from the history data stored in history database 302, thereby enhancing the user's convenience.

In addition, the history data with the identical print setting information is not stored redundantly in history database 302, and therefore only the history data with different print setting information is stored, thereby reducing the volume of history database 302.

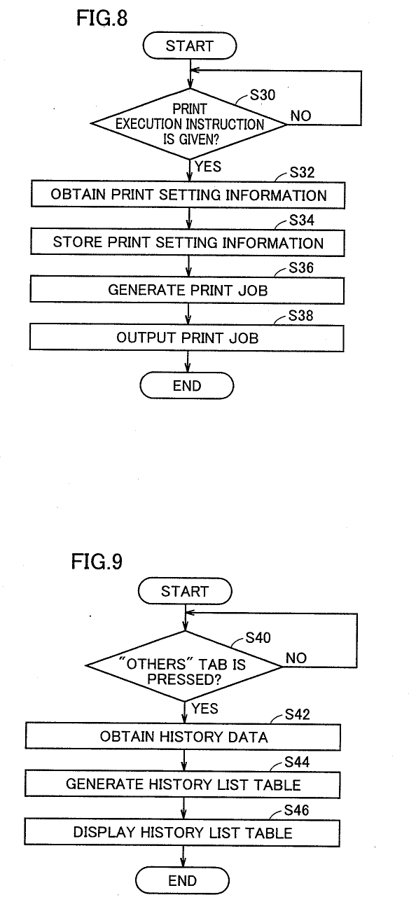

The processing of printer driver 2030 in a case where a print execution instruction is given in accordance with the first embodiment of the present invention will be described using FIG. 8.

Referring to FIG. 8, first, driver core 2090 determines whether or not a print execution instruction is given (step S30). If it is determined that a print execution instruction is given as described above, driver core 2090 obtains print setting information set in the print setting screen by function setting portion 2130 (step S32).

Then, the print setting information is stored (step S34). Specifically, driver core 2090 stores the print setting information at the time of execution of a printing process in HDD 211 or the like.

Then, a print job is generated (step S36).

Specifically, driver core 2090 outputs the obtained print setting information and image data to print data generation portion 2070 and printer control command generation portion 2080 to generate a print job.

Then, the generated print job is output (step S38).

Specifically, driver core 2090 outputs the generated print job to print spooler 2040. Then, the print job formed of the print data and the printer control command is output from print spooler 2040 to image forming apparatus 10 through NIC 207. A printing process is executed in image forming apparatus 10.

In the above-noted process, the print setting information is stored in HDD 211 or the like, so that the print setting information associated with a document editing application is read from HDD 211 when the document editing application is started to execute a printing process again. Then, print setting is executed based on the read print setting information.

Accordingly, environment setting concerning printing is executed based on the previously set print setting information, which eliminates the need for performing an operation for print setting and is thus convenient for the user.

Now, a history list table will be described.

A history list table displayed based on the history data stored in history database 302 will be described using FIG. 9.

Referring to FIG. 9, it is determined whether or not the “others” tab is pressed (step S40).

Specifically, driver core 2090 determines whether or not the “others” tab is pressed (specified), for example, using mouse 270 as a pointing device (step S40).

If it is determined that the “others” tab is pressed in step S40, the history data stored in history database 302 is obtained (step S42). Specifically, history data UT control portion 301 obtains the history data corresponding to the document file stored in history database 302, and history data UI control portion 301 then generates a history list table based on the obtained history data (step S44).

Then, the history list table is displayed (step S46). History data UT control portion 301 displays the history list table in the print setting screen appearing on display 250. The process then ends (END).

It is noted that although in this example it has been described that the history list table is displayed when the “others” tab is pressed, the present invention is not limited thereto. A start button to display the history list table may be provided, or the history list table may be displayed when any other tab is pressed.

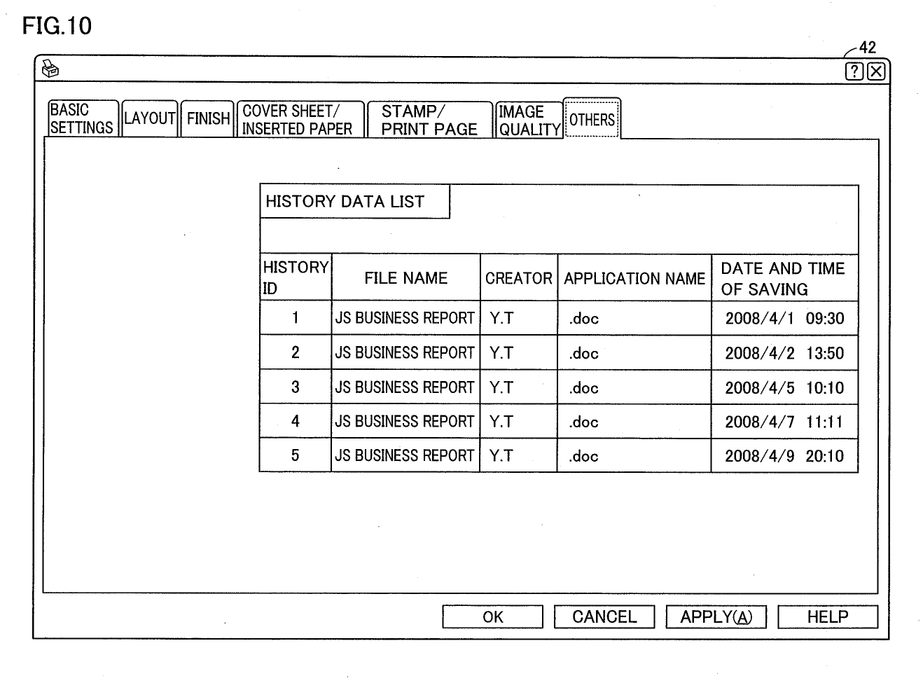

It will be described using FIG. 10 that the history list table is displayed in print setting screen 42.

Referring to FIG. 10, the history list table is displayed by selecting the “others” tab in print setting screen 42, using mouse 270 or the like.

It is assumed that the user can select an item corresponding to a history ID using mouse 270 or the like as a pointing device to set print setting information related with the item corresponding to the history ID, in the history list table.

In this example, history ID 1-5 arranged in ascending order as history ID of print settings, the respective file names, file information such as creators or the like, application names, and the date and time of saving are displayed. Although not shown here, the contents of a specific changing operation regarding print environment settings may be displayed.

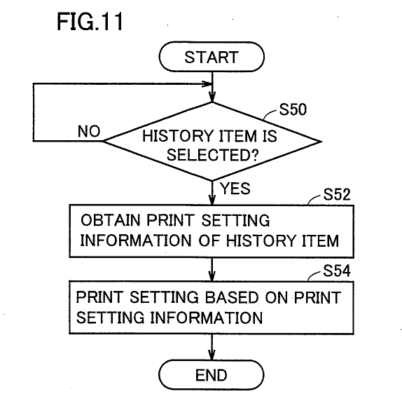

A process in a case where a history item is selected in accordance with the first embodiment of the present invention will be described using FIG. 11.

Referring to FIG. 11, first, it is determined whether or not a history item is selected (step S50). Specifically, driver core 2090 determines whether or not a history item is selected using mouse 270 or the like. If a history item is not selected, the process is on standby at step S50, waiting for a selection input.

Then, if a history item is selected, print setting information is obtained based on the history data of the selected history item (step S52). Specifically, driver core 2090 instructs history data UI control portion 301 to obtain print setting information corresponding to the history ID.

History data UI control portion 301 obtains the print setting information corresponding to the history ID from history database 302 for output to driver core 2090.

Then, print setting is executed based on the print setting information (step S54).

Specifically, driver core 2090 outputs the obtained print setting information to function setting portion 2130, and function setting portion 2130 then executes environment setting concerning printing based on the obtained print setting information.

Then, the process ends (END).

This process allows the user to view the history data concerning print settings operated by the user in the past by the history list table by specifying the “others” tab using mouse 270 or the like as a pointing device. In addition, the past print settings can be changed easily by inputting selection of history data in the history list table, which is convenient for users.

### Second Embodiment

In the first embodiment, the print setting information before a changing operation is stored as history data when the user performs an operation to change an item of print settings using a mouse or the like as a pointing device or the like in the print setting screen.

In a second embodiment of the present invention, a description will be made to a scheme in which the user stores the print setting information set in the print setting screen, as history data, at a prescribed timing as designated by the user.

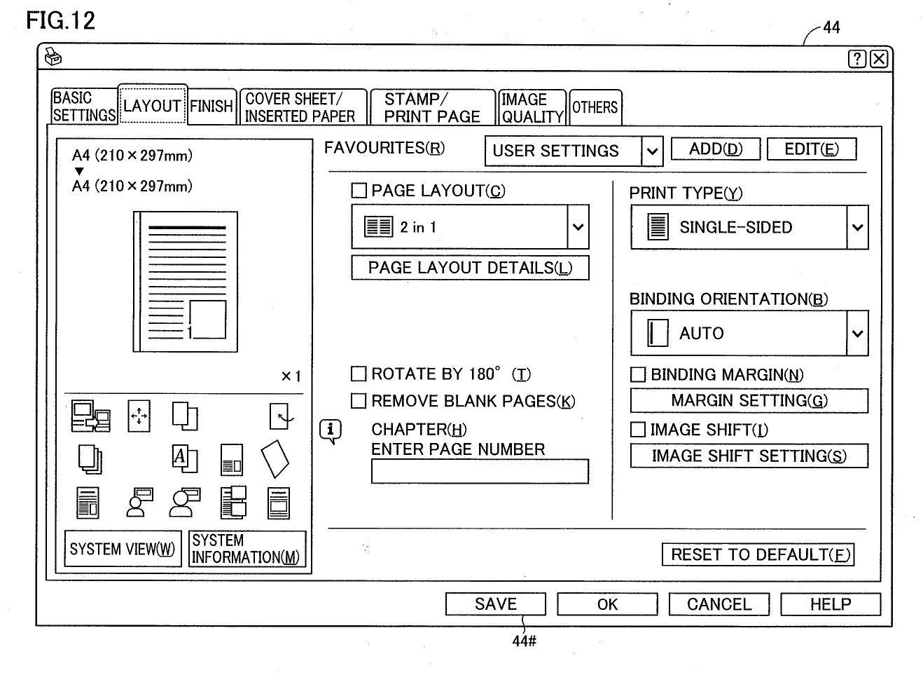

A print setting screen 44 in accordance with the second embodiment of the present invention will be described using FIG. 12.

Referring to FIG. 12, here, a save button 44# is newly provided in print setting screen 44.

The user can store the print setting information set in the print setting screen, as history data, at any given timing for the user, by selecting (pressing) save button 44# using mouse 270 or the like as a pointing device.

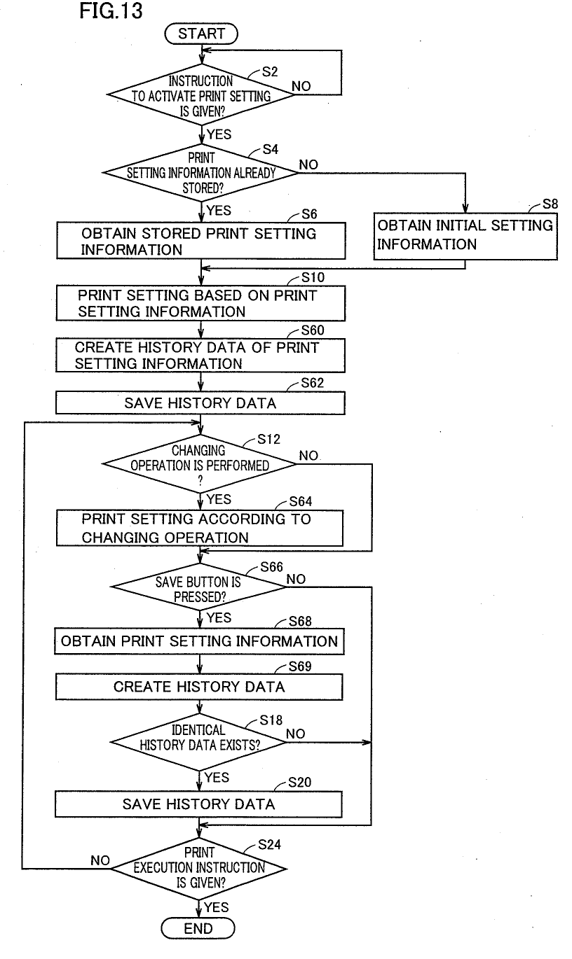

A process procedure of the driver GUI in accordance with the second embodiment of the present invention will be described using FIG. 13.

Referring to FIG. 13, in comparison with the process procedure in FIG. 7, the processes in steps S60, 62 are additionally executed after step S10.

Specifically, after print setting is executed based on the obtained print setting information (step S10), history data of the print setting information is created (step S60).

Specifically, driver core 2090 outputs the obtained print setting information to history data generation portion 300. History data generation portion 300 creates history data based on the obtained print setting information.

The history data is then saved (step S62).

Specifically, history data generation portion 300 saves the created history data in history database 302.

Therefore, in the scheme in accordance with the second embodiment of the present invention, history data is first saved when the print setting screen is activated.

Specifically, the print setting information stored in association with the document editing application when a printing process was performed is first saved as history data. Alternatively, the print setting information that is initial setting information is first saved as history data.

Then, driver core 2090 determines whether or not an operation to change print settings in the print setting screen is performed by the user (step S12).

If a changing operation is not performed in step S12, the process skips to step S66 (NO in step S12).

On the other hand, if a changing operation is performed on an item of print settings through input using the mouse, the keyboard, or the like (YES in step S12), driver core 2090 executes the print setting according to the changing operation (step S64). Specifically, function setting portion 2130 executes environment setting concerning printing based on the print setting information according to the changing operation output from driver core 2090.

Accordingly, setting display portion 2110 displays the updated print setting screen as described above on display 250.

Then, it is determined whether or not the save button is pressed (step S66).

Specifically, driver core 2090 determines whether or not save button 44# in print setting screen 44 is pressed using mouse 270 or the like.

Then, if the save button is pressed, the print setting information is obtained (step S68).

Specifically, driver core 2090 obtains the print setting information set by function setting portion 2130, if save button 44# is pressed.

Then, history data is created (step S69).

Specifically, if it is determined that save button 44# in print setting screen 44 is pressed by the mouse or the like, driver core 2090 outputs the obtained print setting information to history data generation portion 300. History data generation portion 300 creates history data based on the obtained print setting information.

Then, it is determined whether or not identical history data exists (step S18).

Specifically, history data generation portion 300 accesses history database 302 to determine whether history data including the content of print setting information identical to the created history data exists or not.

If it is determined that no identical history data exists in step S18, the history data is saved (step S20).

Specifically, history data generation portion 300 saves the created history data in history database 302. Specifically, the history data as shown in FIG. 6 is saved in history database 302.

Then, driver core 2090 determines whether or not a print execution instruction is given (step S24).

For example, whether a print execution instruction is given or not can be determined by whether or not the user specifies “OK” button using mouse 270 or the like in print setting screen 44.

Then, if it is determined that a print execution instruction is given in step S24, the process in driver GUI 2100 is ended (END). Specifically, display of print setting screen 44 is terminated.

Then, if a print execution instruction is given, driver core 2090 outputs, to print data generation portion 2070 and printer control command generation portion 2080, the set print setting information and image data, which are then output as a print job to print spooler 2040 as described above. Then, the print job formed of these print data and print control command is output from print spooler 2040 to image forming apparatus 10 through NIC 207. A printing process is executed in image forming apparatus 10.

On the other hand, if it is determined that a print execution instruction is not given in step S24 (NO in step S24), the process returns to step S12 again to wait for input of an instruction of a changing operation from the user.

Then, the aforementioned process is repeated.

Therefore, in the scheme in accordance with the second embodiment of the present invention, first, if an instruction to activate the print setting screen is given, history data is first saved, so that the print setting information preset as initial settings can be saved as history data. Alternatively, when print setting information associated with a document editing application is stored in HDD 211 or the like, the stored print setting information can be saved as history data.

Then, every time the user performs an operation to change environment settings concerning printing in the print setting screen and then presses save button 44# at any given timing, the print setting information at the time of changing the environment settings concerning printing can be created as history data and stored in history database 302.

Thus, the user can obtain the past print setting information from the history data stored in history database 302 even when the user operates to change environment settings concerning printing several times using mouse 270 or the like in the print setting screen, thereby enhancing the convenience of the user.

In addition, since the user can press save button 44# at any given time to store the print setting information at the time of pressing, as history data, the print setting information as desired by the user can be saved as a history. Therefore, the print setting information that is not needed to be saved as a history is not stored, thereby reducing the volume of the history database and in addition, facilitating selection of history data displayed in the history list. Moreover, since history data is saved when an instruction to activate print setting is given, as described above, the user can restore the initial print setting state immediately.

### Third Embodiment

In the schemes in the first and second embodiments as described above, print setting information is stored corresponding to an application. In the following embodiments, print setting information is stored for each document file (file data) in relation to an application.

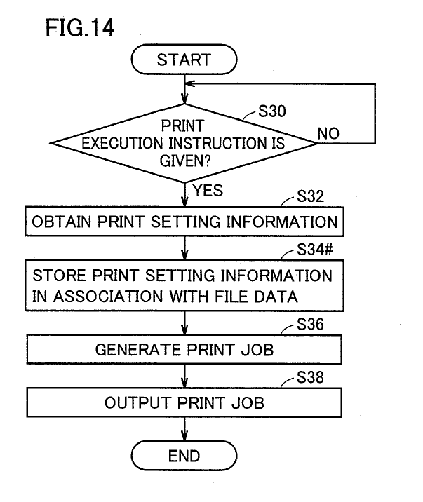

The processing of printer driver 2030 in a case where a print execution instruction is given in accordance with a third embodiment of the present invention will be described using FIG. 14.

FIG. 14 differs from FIG. 8 in that step S34 is replaced with step S34#. The other points are similar as illustrated in FIG. 8, and therefore a detailed description thereof will not be repeated.

Specifically, first, driver core 2090 determines whether or not a print execution instruction is given (step S30). If it is determined that a print execution instruction is given, as described above, driver core 2090 obtains the print setting information set in the print setting screen by function setting portion 2130 (step S32).

Then, the print setting information is stored in association with a document file (file data) (step S34#). Specifically, driver core 2090 associates the print setting information with the document file (file data) at the time of execution of the printing process for storage into HDD 211 or the like.

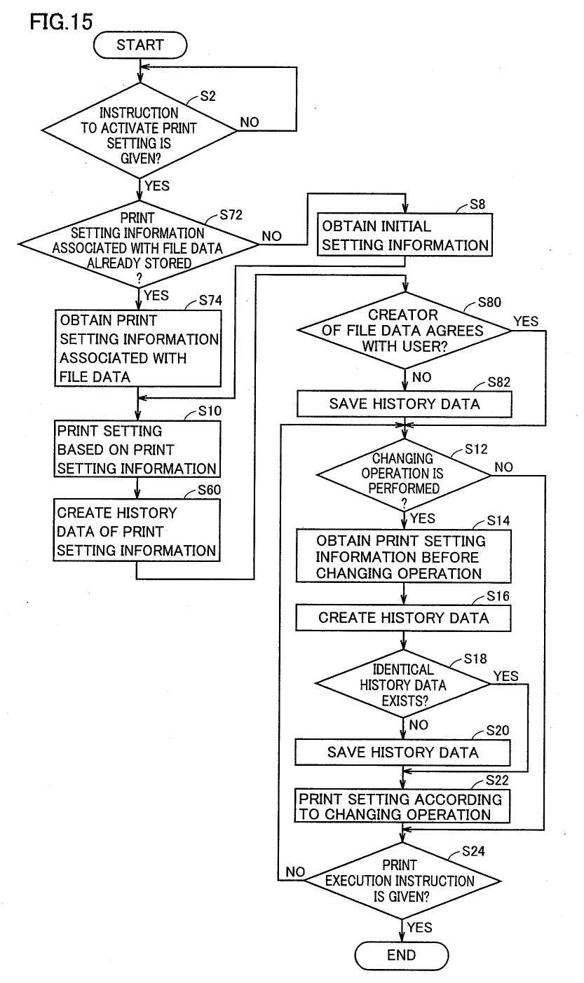

A process procedure of the driver GUI in accordance with the third embodiment of the present invention will be described using FIG. 15.

Referring to FIG. 15, first, driver core 2090 determines whether or not an instruction to activate print setting is given (step S2).

Specifically, it is determined whether or not input of an instruction to activate a print setting screen for executing print environment setting is given by activating a printing process function of a document editing application after the document editing application is started to perform such processing as creation of a new document and opening and editing of the saved document file.

Then, if an instruction to activate print setting is executed in step S2, then driver core 2090 determines whether or not the print setting information associated with the document file (file data) has already been stored (step S72). Specifically, as described above, when a printing process is executed, the print setting information set during the printing process is stored in HDD 211 or the like in association with the document file (file data). It is noted that in the scheme in accordance with the present third embodiment, print setting information is stored in HDD 211 or the like for each file data.

If it is determined that print setting information is stored in step S72, driver core 2090 obtains the print setting information stored in HDD 211 or the like (step S74).

On the other hand, if it is determined that print setting information is not stored in step S72, driver core 2090 obtains the initial setting information (step S8). Specifically, print setting information is not stored when a print data printing process is not executed, and therefore the initial setting information that is the preset print setting information is obtained from HDD 211 or the like.

Then, print setting is executed based on the obtained print setting information (step S10).

Specifically, driver core 2090 outputs the print setting information to function setting portion 2130. Function setting portion 2130 executes environment setting concerning printing that is previously set based on the print setting information output from driver core 2090. Alternatively, function setting portion 2130 executes the initial environment setting concerning printing. Then, setting display portion 2110 displays the above-noted print setting screen on display 250.

Then, driver core 2090 outputs the obtained print setting information to history data generation portion 300. History data generation portion 300 creates history data based on the obtained print setting information (step S60).

Then, it is determined whether or not the creator of the document file (file data) agrees with the user (step S80).

Specifically, driver core 2090 determines whether or not the user information stored in the file information of the document file (file data) agrees with the user information of the user who is currently operating PC.

If the creator of the file data agrees with the user, history data is not saved, and the process proceeds to the next step S12. If the creator of the file data does not agree with the user, that is, if the creator of the created file data is different from the user, history data is saved (step S82). Then, the process proceeds to the next step S12.

The following process is similar as illustrated in FIG. 7, and therefore a detailed description thereof will not be repeated.

In this process, for example, when file data created by any other person is subjected to a printing process, the print setting information set by any other person is saved as history data, and therefore the initially set print setting can be set immediately even when a changing operation is performed.

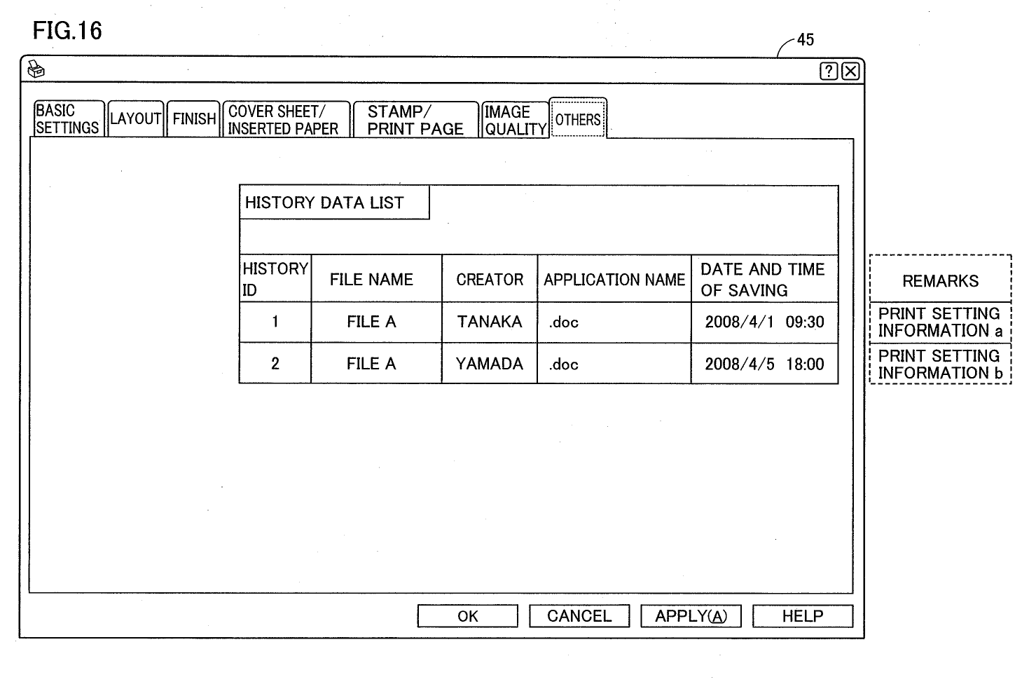

It will be described using FIG. 16 that the history list table is displayed in print setting screen 45.

Referring to FIG. 16, the history list table is displayed by selecting the “others” table in print setting screen 45 using mouse 270 or the like.

It is assumed that the user can set the print setting information related with an item corresponding to a history ID by selecting the item corresponding to the history ID using mouse 270 or the like as a pointing device, in the history list table.

In this example, it is shown that history ID 1, 2 arranged in ascending order as history ID of print settings, the respective file names, file information such as creators, application names, and the date and time of saving are displayed as history items.

In this example, a history list table in a case where the creator of the document file is “Tanaka” while the user is “Yamada” is shown.

It is shown by way of example that when print setting information “a” is stored in HDD 211 or the like in association with the file data of “Tanaka” who is the creator of the document file, the user “Yamada” accesses the file data to perform a changing operation regarding environment settings concerning printing.

Specifically, for example, with reference to the printing system in FIG. 1, in a case where in the environment in which PC is assigned to every user, PC 101 is assigned to “Tanaka” and PC 100 is assigned to “Yamada,” a document file stored in PC 101 assigned to “Tanaka” may be moved to PC 100 assigned to “Yamada” through LAN 20. It is noted that the present invention is not specifically limited to such a situation and a variety of situations are assumed.

Now a description will be made using the flowchart in FIG. 15. After print setting is done based on print setting information “a” associated with the file data of “Tanaka” (step S10), it is determined whether or not the creator of the file data agrees with the user of PC (step S80). Then, in this example, since the creator of the file data does not agree with the user of PC, the created history data is saved (step S82). Then, in this example, it is shown that when the user “Yamada” performs an operation to change to print setting information “b” in the print setting screen and thereafter further performs a changing operation, the history data concerning print setting information “b” is saved.

It is noted that though not shown here, the contents of a specific changing operation concerning print environment setting as shown in the remarks may be displayed.

Therefore, even when the user “Yamada” performs an operation to change print environment settings, he can easily restore the initial print environment settings by selecting the item corresponding to history ID 1 corresponding to the initial print setting information “a.”

### Fourth Embodiment

In the scheme in accordance with a fourth embodiment, a manner of displaying a history list table in the print setting screen will be described.

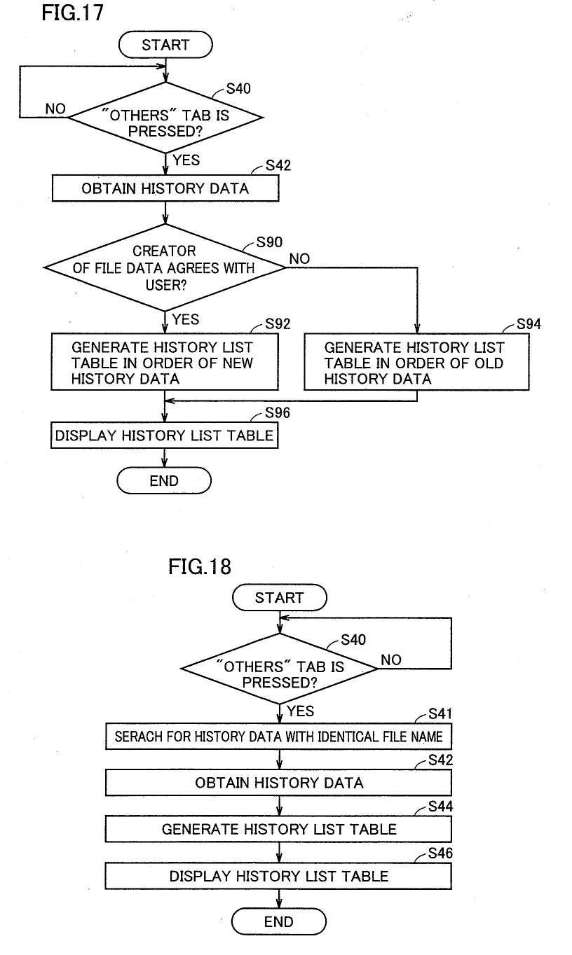

Display of the history list table in accordance with the fourth embodiment of the present invention will be described using FIG. 17.

Referring to FIG. 17, first, it is determined whether or not the “others” tab is pressed (step S40).

If it is determined that the “others” tab is pressed in step S40, the history data stored in history database 302 is obtained (step S42). Specifically, history data UI control portion 301 obtains the history data stored in history database 302.

Then, it is determined whether or not the creator of the file data agrees with the user (step S90). Specifically, driver core 2090 determines whether or not the user information stored in the file information of the document file (file data) agrees with the user information of the user who is currently operating PC, as described above.

Driver core 2090 outputs to history data UI control portion 301 whether the creator of the file data agrees or disagrees with the user.

If the creator of the file data agrees with the user in accordance with the output specified by driver core 2090, history data UI control portion 301 generates a history list table in order of new history data (step S92).

On the other hand, if the creator of the file data disagrees with the user in accordance with the output specified by driver core 2090, history data UI control portion 301 generates a history list table in order of old history data (step S94).

Then, the generated history list table is displayed (step S96). History data UI control portion 301 displays the history list table in the print setting screen appearing on display 250. The process then ends (END).

This processing allows a manner of displaying the history list table to be changed in consideration of the convenience of the user.

Specifically, if the creator of the file data agrees with the user, history data is arranged in order of new history data, so that the history data that was changed most recently can be recognized immediately and the previous print environment settings can be restored immediately.

On the other hand, if the creator of the file data is different from the user, even when the print environment settings are operated to be changed, the original print environment settings set by the creator of the file data can be set immediately. Therefore, the convenience can be expected to be high.

In the present example, the form of display of the history list table is changed depending on whether the creator of the file data agrees with the user or not. However, considering the user's convenience, for example, the arrangement may be changed in accordance with an instruction from the user. For example, radio buttons may be provided respectively in order of the date and time of saving or in the reverse order.

A description has been made to the scheme of changing arrangement depending on whether the creator of the file data agrees with the user or not. However, when the creator is different from the user, they may be color-coded to facilitate visual recognition of history data. Alternatively, when the creator of the file data is different from the user, their history data lists may be displayed separately.

### Fifth Embodiment

In the scheme in accordance with a fifth embodiment, another manner of displaying the history list table in the print setting screen will be described.

Display of the history list table in accordance with the fifth embodiment of the present invention will be described using FIG. 18.

Referring to FIG. 18, first, it is determined whether or not the “others” tab is pressed (step S40).

If it is determined that the “others” tab is pressed in step S40, the history data having the identical file name is searched for (step S41). Specifically, history data UI control portion 301 searches for the history data having the identical file name that is stored in history database 302.

Then, the history data having the identical file name that is stored in the searched history database 302 is obtained (step S42). Specifically, history data UI control portion 301 obtains the history data that is searched for by the identical file name and found in history database 302.

Then, a history list table is generated based on the obtained history data (step S44). History data UI control portion 301 generates a history list table based on the obtained history data.

Then, the generated history list table is displayed (step S46). History data UI control portion 301 displays the history list table in the print setting screen appearing on display 250. The process then ends (END).

In general, as for software applications operating on computers, file data created by one software application is provided with an identifier together with a file name in order to be distinguished from file data of another software application.

For example, file data is stored with an identifier “DOC” for “Word” that is a software application included in Office of Microsoft (R), with an identifier “XLS” for “Excel,” and with an identifier “TPT” for “Power Point”. Furthermore, when data is converted into a text document, it is stored with “TXT” as an identifier in a case of the software application “Notepad.”

Since these identifiers represent application names different from each other, the files may have the same file name.

When users creates file data using each software application for one case, they are likely to specify the same file name.

Therefore, it is likely that a plurality of file data having the same file name and having different identifiers exist in HDD 211.

It is convenient for users to collectively manage these file data, which have their respective different identifiers but have the same file name.

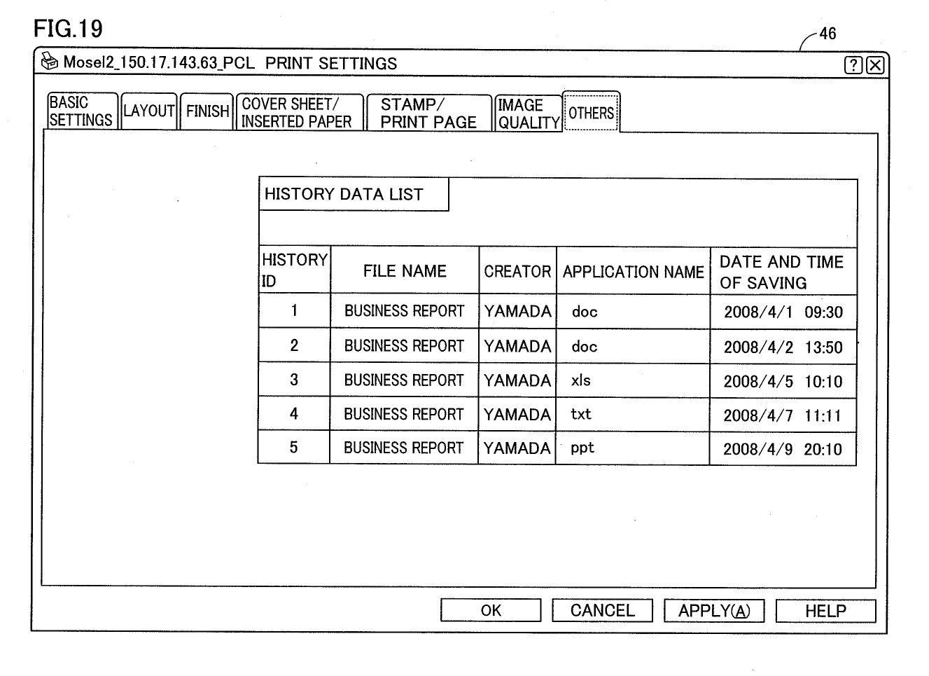

It will be described using FIG. 19 that a history list table is displayed in print setting screen 46.

Referring to FIG. 19, a history list table is displayed by selecting the “others” tab in print setting screen 45 using mouse 270 or the like.

It is assumed that the user can set print setting information related with an item corresponding to a history ID by selecting the item corresponding to the history ID using mouse 270 or the like as a pointing device, in the history list table.

In the present example, it is shown that history ID 1-5 arranged in ascending order as history ID of print settings, their respective file names, file information such as creators, application names, and the date and time of saving are displayed.

In the present example, a history list table of the same file name “business report” is shown.

Shown as file data of “Yamada” who is the creator of the document file is a list of history data of file data with the file name “business report” created by “Word,” history data of file data with the file name “business report” created by “Excel,” history data of file data with the file name “business report” created by “Notepad,” and history data of file data with the file name “business report” created by “Power Point,” by way of example.

Therefore, the user can refer to the history data of file data related with any other software application and can set print environment settings easily based on the history data set by the other software application.

Although not displayed here, the contents of a specific changing operation regarding print environment settings as shown in the remarks may be displayed.

It is noted that a program that allows a computer to function and execute the control as illustrated in the above-noted flows may be provided. Such a program may be recorded in a computer readable recording medium such as a flexible disk, a CD-ROM (Compact Disk-Read Only Memory), a ROM (Read Only Memory), a RAM (Random Access Memory), and a memory card, which accompanies a computer, and be provided as a program product. Alternatively, the program may be recorded in a recording medium such as a hard disk contained in a computer. Alternatively, the program may be downloaded via a network.

The program may allow the process to be executed by invoking necessary modules, among program modules provided as a part of Operating System (OS) of a computer, in a prescribed sequence at a prescribed timing. In this case, the aforementioned modules are not included in the program itself and the process is executed in cooperation with OS. The program that does not include such modules may also be included in the program in accordance with the present invention.

Furthermore, the program in accordance with the present invention may be built in a part of another program. In this case, the modules included in another program are not included in the program itself, and the process is executed in cooperation with another program. Such a program built in another program may also be included in the program in accordance with the present invention.

The program product to be provided is installed in a program storage portion such as a hard disk for execution. It is noted that the program product includes the program itself and a recording medium having the program recorded thereon.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An information processing apparatus transferring image data created by a software application operating on a computer to an image forming apparatus for printing, comprising:
a display for displaying information: and
a controller for controlling said information processing apparatus, said controller being configured to
i) display a print setting screen on said display for setting print setting information showing a manner of printing of said image data in said image forming apparatus that is transferred in association with said image data when printing of said image data is to be executed,
ii) obtain print setting information before being changed in response to an operation to said print setting screen that receives a change of said print setting information, and
iii) save the obtained print setting information before being changed into a memory as history information that is to be used for displaying on said display said print setting screen in relation to the saved print setting information.

2. The information processing apparatus in accordance with claim 1, wherein
the print setting information set when printing of said image data is executed is stored in said memory in relation to said image data,
said controller displays said print setting screen again on said display based on the saved print setting information stored in said memory in relation to said image data in response to an instruction, and
when said print setting screen is displayed again on said display, the saved print setting information stored in said memory is saved in said memory as said history information.

3. The information processing apparatus according to claim 1, wherein said controller detects input of a saving instruction in said print setting screen to obtain the print setting information before being changed.

4. The information processing apparatus according to claim 1, wherein said controller obtains the print setting information before being changed when the print setting information is changed to another print setting information.

5. The information processing apparatus according to claim 1, wherein said controller
obtains information of a creator of said image data and of a user of said computer,
compares the information of the user of said computer with the information of the creator of said image data, and
saves said print setting information before being changed as history information in said memory when said creator is different from said user.

6. The information processing apparatus according to claim 1, wherein said controller
allows said display to display a list of plural pieces of print setting information saved in said memory as said history information, in response to an instruction,
accepts input of selection of one piece of print setting information from said list of plural pieces of print setting information, and
displays a print setting screen in accordance with the selected print setting information on said display.

7. The information processing apparatus according to claim 6, wherein said controller allows said display to display said plural pieces of print setting information in chronological order.

8. The information processing apparatus according to claim 7, wherein said controller
obtains information of a creator of said image data and of a user of said computer,
compares the information of the user of said computer with the information of the creator of said image data, and
allows said display to display said plural pieces of print setting information in chronological order when said creator is different from said user.

9. The information processing apparatus according to claim 6, wherein said controller
obtains information of a creator of said image data and of a user of said computer,
compares the information of the user of said computer with the information of the creator of said image data, and
allows said display to display said plural pieces of print setting information in reverse chronological order when said creator and said user are identical.

10. The information processing apparatus according to claim 6, wherein
said image data is managed with a file name in association with an identifier showing a software application that has created said image data among a plurality of identifiers respectively corresponding to a plurality of software applications,
plural pieces of other print setting information are saved in said memory in relation to respective plural pieces of image data, and
said controller
saves said file name and said identifier corresponding to each said image data in association with each other, together with said print setting information or said other print setting information, as said history information in said memory, and
allows said display to display a list including print setting information corresponding to identical said file name among said print setting information and said plural pieces of other print setting information that are saved in said memory.

11. A method of controlling an information processing apparatus transferring image data created by a software application operating on a computer to an image forming apparatus for printing, comprising the steps of:
displaying a print setting screen on a display for setting print setting information showing a manner of printing of said image data in said image forming apparatus that is transferred in association with said image data when printing of said image data is to be executed;
obtaining print setting information before being changed in response to an operation to said print setting screen that receives a change of said print setting information; and
saving the obtained print setting information before being changed into a memory as history information that is to be used for displaying on said display said print setting screen in relation to the saved print setting information.

12. The method of controlling an information processing apparatus according to claim 11, further comprising the steps of:
storing print setting information set when printing of said image data is executed, into said memory in relation to said image data;
displaying said print setting screen again on said display based on the saved print setting information stored in said memory in relation to said image data in response to an instruction;
saving the saved print setting information in said memory as said history information when said print setting screen is displayed again on said display.

13. The method of controlling an information processing apparatus according to claim 11, wherein said obtaining step includes the step of obtaining said print setting information before being changed when the print setting information is changed to another print setting information.

14. The method of controlling an information processing apparatus according to claim 11, wherein said obtaining step includes the steps of
obtaining information of a creator of said image data and of a user of said computer,
comparing the information of the creator of said image data with the information of the user of said computer, and
saving said print setting information before being changed in said memory as history information when said creator is different from said user.

15. The method of controlling an information processing apparatus according to claim 11, further comprising the steps of:
allowing said display to display a list of plural pieces of print setting information saved in said memory as said history information, in response to an instruction;
accepting input of selection of one piece of print setting information from said list of plural pieces of print setting information; and
displaying a print setting screen in accordance with the selected print setting information, on said display.

16. A recording medium having a control program recorded thereon for an information processing apparatus that transfers image data created by a software application operating on a computer to an image forming apparatus for printing,
said control program allowing said computer to execute the steps of:
displaying a print setting screen on a display for setting print setting information showing a manner of printing of said image data in said image forming apparatus that is transferred in association with said image data when printing of said image data is to be executed;
obtaining print setting information before being changed in response to an operation to said print setting screen that receives a change of said print setting information; and
saving the obtained print setting information before being changed into a memory as history information that is to be used for displaying on said display said print setting screen in relation to the saved print setting information.

17. The recording medium having a control program recorded thereon according to claim 16, wherein said control program allows said computer to further execute the steps of:
storing print setting information set when printing of said image data is executed, into said memory in relation to said image data;
displaying said print setting screen again on said display based on the saved print setting information stored in said memory in relation to said image data in response to an instruction;
saving the saved print setting information in said memory as said history information when said print setting screen is displayed again on said display.

18. The recording medium having a control program recorded thereon according to claim 16, wherein said obtaining step includes the step of obtaining said print setting information before being changed when previous print setting information is changed to another print setting information.

19. The recording medium having a control program recorded thereon according to claim 16, wherein said obtaining step includes the steps of
obtaining information of a creator of said image data and of a user of said computer,
comparing the information of the creator of said image data with the information of the user of said computer, and
saving said print setting information before being changed in said memory as history information when said creator is different from said user.

20. The recording medium having a control program recorded thereon according to claim 16, wherein said control program allows said computer to further execute the steps of:
allowing said display to display a list of plural pieces of print setting information saved in said memory as said history information, in response to an instruction;
accepting input of selection of one piece of print setting information from said list of plural pieces of print setting information; and
displaying a print setting screen in accordance with the selected print setting information, on said display.
